(19) United States
(12) Patent Application Publication
(10) Pub. No.: US 2014/0156677 A1
(43) Pub. Date: Jun. 5, 2014

(54) ORDERING CURATED CONTENT FOR ACCESS VIA A PLAYPACK

(71) Applicant: Playrific, Inc., Billerica, MA (US)

(72) Inventors: Theodore Joseph Collins, III, Billerica, MA (US); Beth Marcus, Bedford, MA (US)

(73) Assignee: Playrific, Inc., Billerica, MA (US)

(21) Appl. No.: 14/162,325

(22) Filed: Jan. 23, 2014

Related U.S. Application Data
(63) Continuation-in-part of application No. 12/963,105, filed on Dec. 8, 2010.
(60) Provisional application No. 61/781,183, filed on Mar. 14, 2013.
(60) Provisional application No. 61/283,717, filed on Dec. 8, 2009.

(51) Int. Cl. G06F 17/30

(52) U.S. Cl. CPC G06F 17/30023
USPC 707/748

(57) ABSTRACT

A presentation order of curated media items that are represented by meta data in a playpack is determined by evaluating a platform score, a viewer score, a content popularity score, a content quality score, and a scatter algorithm.

### CROSS-REFERENCE TO RELATED APPLICATIONS

This application claims the benefit of U.S. provisional application Ser. No. 61/781,183 filed Mar. 14, 2013, which is hereby incorporated by reference in its entirety.

This application is a continuation-in-part of U.S. patent application Ser. No. 12/963,105 filed Dec. 8, 2010, which claims the benefit of U.S. provisional application Ser. No. 61/283,717 filed Dec. 8, 2009, each of which are hereby incorporated by reference in its entirety.

### BACKGROUND

1. Field

This disclosure relates to the field of children's use of remote mobile computing, and specifically automatically gathering data into a central database from children's use patterns on remote mobile computing devices.

2. Description of Related Art

The Internet gives broad access to a variety of digital media, including images, music, interactive visual programs, and video. Because the Internet's organizing principles do not take into consideration the quality or appropriateness of a particular piece of digital media for a particular viewer, media items desired by that viewer may be inter-mixed with undesired media items. In some cases, this inter-mixing can effectively hide the desired content from a particular viewer, because manually sorting many media items can become prohibitively time-consuming. In the case of viewers who are children, the problem becomes more acute, because the Internet has is no means of eliminating inappropriate media items entirely. Thus, precisely because the Internet gives broad access without filtering mechanisms for children in particular, providing appropriate media items while screening inappropriate ones is a significant technical challenge. For example, if an adult searches for Cars the adult might get car dealers, car repair, car racing, driving lessons, car parts, and the like. By observing these results, the adult may readily narrow the search in a good direction. However, if a child asks for Cars, the child may want the Cars movie, small collectible cars, car racing games, books, games, or videos about cartoon or real cars depending on the child's age and other interests. Internet content is also typically delivered in siloed channels and/or through character or brand-based web sites and applications, which can significantly alter the range of content options presented. In addition, viewers have a limited amount of time in which to view media items. In the case of an adult viewer, this may be due to competing demands for time which limit the time that adult viewer may devote to viewing media items. In the case of viewers who are children, this may be due to limited patience and attention. In either case, it is highly desirable to quickly locate and present media items.

In addition, each viewer has separate desires and interests. Conversely, each viewer has generalized personal likes and dislikes which influence whether they like or dislike a particular media item. For example, a young viewer may like purely traditional educational media items, and like ones that present bright colors and visual action. As that same viewer grows older, his or her likes and dislikes change. A media item, which is a personal favorite for many weeks, may become distasteful as the viewer ages and his or her interests mature. For example, a viewer who loves animals may like cartoon animal characters doing cute things when they are young. However this viewer's preferences may evolve to prefer realistic and educational footage, books, and games as the viewer gets older.

In addition, each physical device that displays media items has specific capabilities and limitations. A media item presented on one device may give a substantively different user experience if presented on another device with more or less limited capabilities.

In 1998, the United States enacted the Children's Online Privacy Protection Act (COPPA) (15 USC §§6501-6506 (Pub.L. 105-277, 112 Stat. 2581-728, 1998). Since that date, regulations have been promulgated which proscribe certain data gathering practices as regards children. Most software for remote mobile devices gathers usage data as a by-product. For example, a game application might gather data on what levels are the most popular, or which animated characters are the most played. The purpose of gathering this “by-product data” is to inform improvement of the game and design of future games. The law divides gathering “by-product data,” as regards children, into two categories:

a) With Verified Parental Consent (VPC); and

b) Without Verified Parental Consent.

### SUMMARY

It is desirable to organize media items according to general appropriateness for a category of viewer. In the case of children, it may be desirable to organize media items around age categories and by viewer gender. It is further desirable to track the availability of particular media items. In this way, a system could present a viewer with a list of only those items that are currently viewable, based on network availability, bandwidth, for example. It is further desirable to refine the general likes and dislikes of a general group, and sharpen the likes and dislikes to a specific viewer. For example, a particular viewer's interests in one subject may strengthen as the viewer matures, while certain other interests diminish.

However, organizing media items around subject matter topics and letting the observed child's browsing and consuming habits contribute to a determination of the child's development or interest that is then used to adjust content availability to the viewer may make the viewer's experience more satisfying over time. This may provide an initial framework for a recommendation engine that may operate on the principle that viewer's interests can be grouped according to observable attributes, and that there exists a high probability that a particular viewer will like most items within a group.

And additionally, a particular viewer may view media items on a variety of physical devices. Each device exhibits certain strengths and weaknesses technically. It is desirable to organize media items according to which ones yield the most advantageous user experience, based on available device capabilities. By organizing media items according to these principles, the viewer's experience can be significantly streamlined and otherwise made more satisfying.

Methods and systems of ordering curated content for use in a Playpack may include a method of determining a measure of media items that are accessible via metadata stored in a Playpack, including determining a platform assessment score that includes a screen score, a network factor, a network speed, and a touch screen score; determining a viewer assessment score that includes a presentation score, a duration score, a taxonomy score, and repeated view tolerance score; determining a content assessment score that includes a popularity weighting score and a quality score; and ordering the media items based on content assessment score and viewer assessment score. In this method, the quality score is based on comparing platform assessment score factors with media item meta data.

Methods and systems of ordering curated content for use in a Playpack mode may include a method of determining a presentation order of media items that are accessible via metadata stored in a Playpack that may include determining a platform assessment score that includes a screen score, a network factor, a network speed, and a touch screen score; determining a viewer assessment score that includes a presentation score, a duration score, a taxonomy score, and repeated view tolerance score; determining a content popularity weighting score; determining a content quality score that is based on comparing platform assessment score factors with media item meta data; ordering the media items based on content popularity weighting score, content quality score and viewer assessment score; and applying a scatter algorithm to re-order the ordered media items based on a viewer repetition tolerance factor.

Methods and systems of ordering curated content for use in a Playpack mode may include a media item recommendation engine for recommending a next item to present to a child that is selected from a plurality of media items that are represented by metadata stored in a Playpack that may include a platform assessment score that includes a screen score, a network factor, a network speed, and a touch screen score; a viewer assessment score that includes a presentation score, a duration score, a taxonomy score, and repeated view tolerance score; a content popularity weighting score; a content quality score that is based on comparing platform assessment score factors with media item meta data; a media item presentation order sorting facility for ordering the media items based on content popularity weighting score, content quality score and viewer assessment score; and wherein a media item that appears at the top of the presentation order is the recommended next item to present to the child.

The instant disclosure concerns protecting and safeguarding the identity of children online. The disclosure shows one or more means of encrypting identifying information about children, and separating the encrypted data such that it can be un-encrypted with the consent of the parent. The disclosure further shows one or more means of tailoring messages for communication with specific children exhibiting specific behavior patterns—without compromising their identity. This disclosure concerns gathering “by-product data,” as regards children without verified parental consent (VPC): activities of children on mobile computing devices where there is no VPC. It may seem desirable to require VPC for any software in use by children. However, in practice it is far the more common to gather without VPC. Parents or care-givers lack time to monitor their children's behavior on remote mobile computing devices. Additionally, they lack expertise to make informed decisions about which software and which features to permit on remote mobile devices for their children. And, most commonly, children circumvent their parents and use software of their own choosing without the parents' knowledge.

This disclosure concerns mobile computing devices which are connected to a network by some means, most commonly IEEE 802.11 (WiFi), or other mobile telemetry technology. Further, this disclosure excludes software which operates exclusively on the remote mobile device, and does not make any connection to the Internet.

The problem which this disclosure solves is an industry-wide problem of how to safely and effectively gather certain data about children's interaction with specific software, without violating COPPA, and without creating a risk of misuse of the collected data. The need for gathering this data is great. At a minimum, it informs the software manufacturers about how their software is used; and that leads to much better software. It also provides trending information which can inform decision makers about how to plan for and improve future children's software and computing. It also enables software manufacturers to provide narrower, more personalized recommendations on which other software a child might like. And finally, if properly gathered and stripped of identifying information, the information can benefit third parties with a commercial interest in children, their interests, and their behavior patterns on remote mobile devices.

From a public policy standpoint, it may seem objectionable to permit software companies to gather information on children's activities. But as a practical matter, children circumvent exclusion guards regularly, and gain access to software and networking facilities intended for well-informed adults. For this reason (that it can be almost impossible to distinguish from adults using remote mobile devices) extra precautions should be taken to protect privacy of all users, including the children disguised as adults. And, while a primary use of gathering data on children is advertising of products, some might also object to the wisdom of permitting data gathering at all. This ignores the economic reality, however, that all users benefit from advertising-supported software inasmuch as they receive state-of-the-art software for free. So, while some users can afford licensing fees for information technology, most cannot afford it. Thus, advertising-supported software enterprises serve a larger population of children without regard to their economic means, if they provide advertising-supported technology. And advertising-supported technology gathers use information as a by-product.

In summary, the challenge is two-fold. First, how to safely gather, and then securely analyze data on interactions within software intended for adults, but in part used by kids without parental knowledge, and where detecting the real age and sophistication of a user is difficult or impossible. Second, how to safely gather, and then securely analyze data on interactions within software intended for children, but used without express parental consent.

Methods and systems of safe monitoring of child behavior and use of behavior data may include a method operable on a digital Computer Server (CS) and one or more Remote Computing Devices (RMD) that may include encrypting an identity of a child operating an application on the RMD with a two-way encryption algorithm use a public encryption key and a secret encryption key; storing the encrypted identity in a memory that is accessible by the CS; storing the secret encryption key separately from the encrypted identity; transmitting child RMD operator usage data from the RMD to the CS; and storing the RMD operator usage data with reference to only the public encryption key.

### BRIEF DESCRIPTION OF THE FIGURES

The invention and the following detailed description of certain embodiments thereof may be understood by reference to the following figures:

FIG. 1 depicts a functional diagram of Playpack components;

FIG. 2 depicts a system diagram showing how Playpacks are employed;

FIG. 3 depicts a flow diagram showing the method by which Playpacks function;

FIG. 4 depicts a flow diagram showing a method employed for recommending media item presentation order; and

FIGS. 5-10 depict steps to create, configure, upload, and preview a Playpack.

FIG. 11 depicts Remote Mobile Devices (RMD) Connected via Network Connections to Central Server (CS);

FIG. 12 depicts applications and interactivity data;

FIG. 13 depicts a device with unique device-specific code;

FIG. 14 depicts progressive representations of usage data;

FIG. 15 depicts encryption of usage data without destroying usefulness of anonymized components;

FIG. 16 depicts parent granting consent for gathering and use of usage data for a specific child;

FIG. 17 depicts transmitting and storing anonymized behavior information;

FIG. 18 depicts finding patterns in anonymized data;

FIG. 19 depicts enabling parents to control children's identity information; and

FIG. 20 depicts controlling messaging targeted at a specific child without revealing identity to message sender.

### DETAILED DESCRIPTION

While described herein with reference to various embodiments, it is understood that, in all cases, unless otherwise specified, references to an “embodiment” or “embodiments” refer to one or more exemplary and non-limiting embodiments. Also, it is understood that, in all descriptions herein, unless otherwise specified, even when not explicitly being referenced to an “embodiment” or “embodiments” refer to one or more exemplary and non-limiting embodiments.

The methods and systems of safe child device use behavior monitoring, storage and use may be beneficially applied to the safe child device use systems and methods described in U.S. provisional application Ser. No. 61/781,183 and in U.S. non-provisional application Ser. No. 12/963,105, each of which are hereby incorporated herein in its entirety. In Ser. No. 12/963,105 methods and systems of child-safe media interaction are described. One such embodiment includes a safe-media interaction system that includes distinct child and parent interfaces through which a child can interact with content and applications that are selected and authorized by a parent through the parent interface. The applications and content interactions of this system may be monitored through the methods and systems for safe child behavior monitoring described herein. The child interface allows a young child who has not yet acquired any reading skills, verbal skills, or visual organization skills to select a content item or application feature from a selection of such items/features visually presented to the child and interact with the selected item/feature through a general purpose computer interface such as a touch screen or keyboard with labels placed over selected keys. The safe-media interaction system also supports special purpose interfaces such as remote controls, kid-safe toys, and a dance pad to facilitate early childhood use of the system.

In 61/781,183, ordering curated content for access via a Playpack function may be applied to the child-safe media interaction methods and systems of Ser. No. 12/963,105. A presentation order of curated media items that are represented by meta data in a playpack may be determined by evaluating a platform score, a viewer score, a content popularity score, a content quality score, and a scatter algorithm. Interacting with ordered curated content and use of a Playpack capability may be monitored with the safe child behavior monitoring and data usage capabilities described herein.

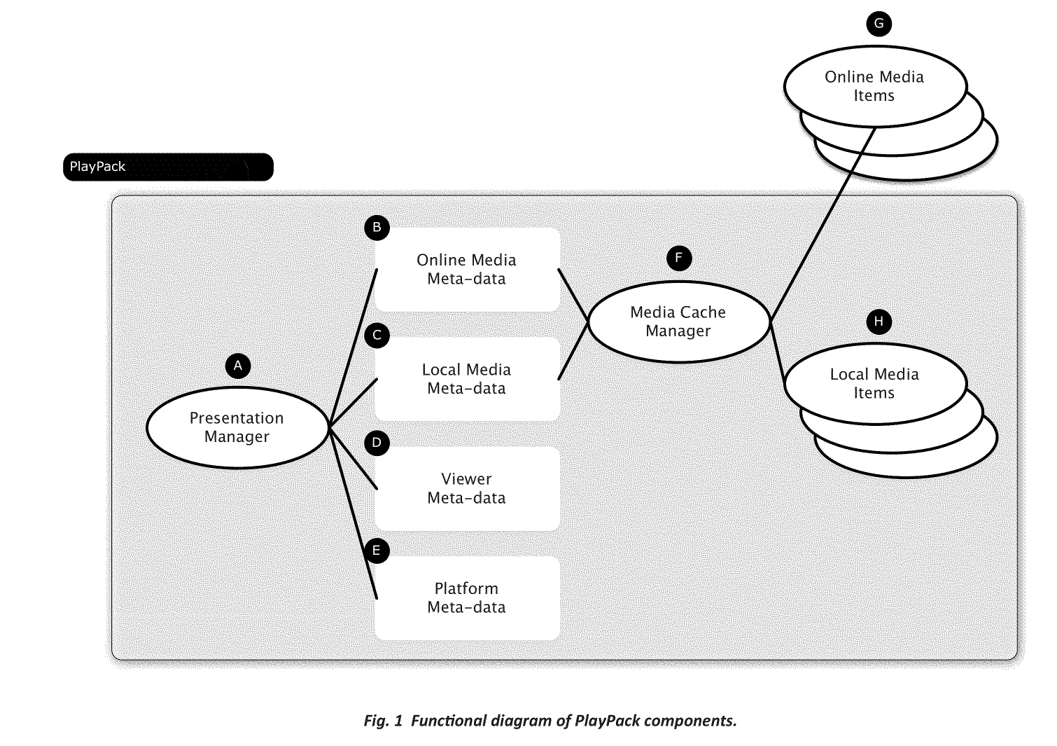

Referring to FIG. 1, a functional diagram of Playpack components, a Playpack organizes digital media for viewing and interaction by a user. A Playpack organizes at least two types of digital media, “Online” media (G), and “Local” media (H). “Media” refers to digital representations of images, audio, interactive graphic programs, video, games, books, and the like. A Media Item is considered to be “Online” when it is available by using the display system to access a remote server through a network connection. A Media Item is considered to be “Local” when it is available by accessing storage media with the display system without requiring a use of the network connection. A Playpack uses a Media Cache Manager (F) to provide a consistent means of accessing both Online (G) and Local (H) Media Items. In this way, all Media Items are accessed in a substantially similar manner, while the Playpack determines which Media Items can be accessed and displayed.

The Playpack determines which Media Items to make available for display based on “Meta-data,” or “data about the data.” The Meta-data employed by the Playpack may consist of various information about Online Media (B) and Local Media (C). The Playpack also consists of information about viewers who use a particular display device to access the Playpack content (D). The Playpack accumulates this Meta-data about the viewers likes and dislikes by storing and updating the information over time. Finally, the Playpack uses information about the display device, or “Platform” (E). These elements of Meta-data can be combined in one or more ways to sort Media Items, and present them in an order and frequency desirable to the viewer (A).

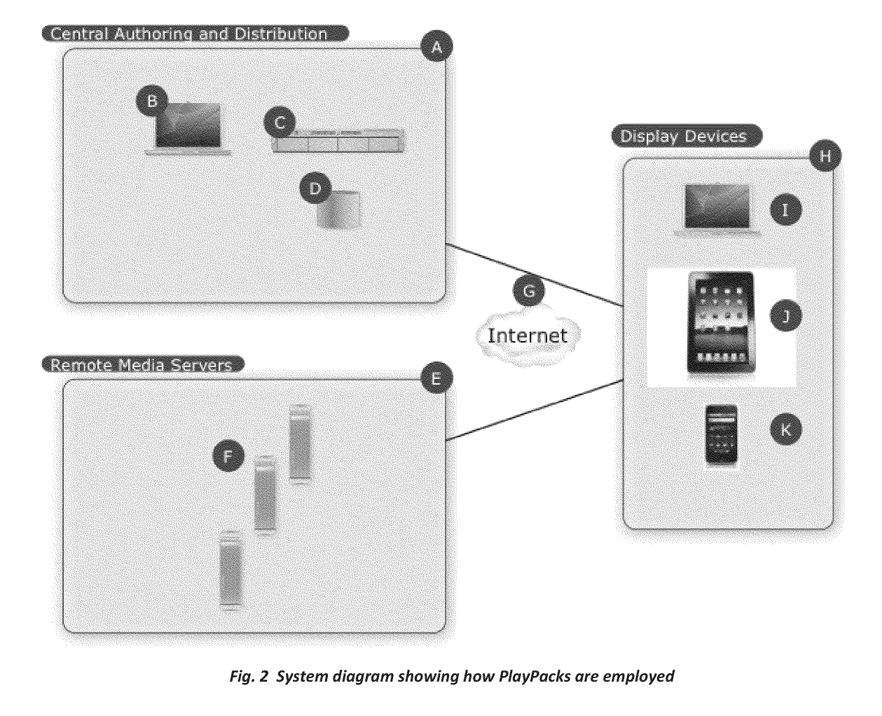

This disclosure describes and depicts a system for organizing and managing one or more digital Media Items. FIG. 2 shows the relationships between the components of this system.

To create a Playpack, a user employs one or more Central Authoring and Distribution servers (A). “Authoring” a Playpack consists of selecting one or more Media Items and recording Meta-data about each one inside the Playpack. This is accomplished by using an interactive program on an Authoring Computing Device (B), to enter information via a network connection to a Distribution Server (C). The Distribution Server (C) stores each Playpack on storage devices (D) which are electrically connected to the Distribution Server. Playpacks are then transmitted via the Internet (G) to one or more Display Devices (H). Display Devices include laptop/desktop computers (I), Tablet Devices (J), Smartphone Devices (K), or the like. Each of the Display Devices locally stores a copy of the Playpack. An interactive program on each Display Devices uses information stored in the Playpack to select one or more Media Items for presentation to a viewer. The Media Items displayed in this manner may be either Online (E), in which case, the Display Device accesses them via the Internet for presentation to the user; or Local (H), in which case they are accessed via local storage devices on the Display Device.

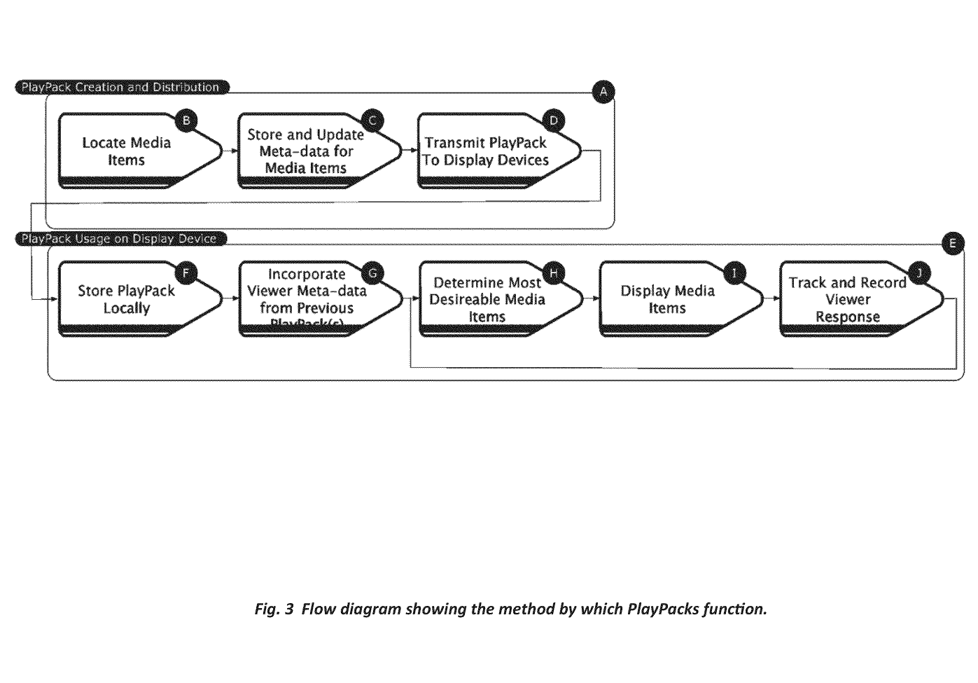

This disclosure describes and depicts a method for organizing, selecting, and deploying digital Media Items via the Internet. FIG. 3 shows the functional relationships between each procedure in the method.

FIG. 3 shows how the method of creating and using a Playpack flows. The top line of this diagram shows how locating Media Items, and then recording Meta-data information about each Media Item may create Playpacks. The bottom line of this diagram shows the method by which the Playpack determines the most desirable Media Item for presentation to a particular viewer, on a particular device, at a particular time. Beginning with Playpack creation (A), a user first locates and selects appropriate Media Items for inclusion in a Playpack (B). The Playpack is created, and the Meta-data about each Media Item within the Playpack is stored for later reference (C). When the user determines that a Playpack is complete, the user finalizes the Playpack and transmits (D) it via the Internet to one or more Display Devices.

On the Display Device (E), which is any of a desktop computer, a tablet, a smart phone, and the like, the Playpack in cooperation with an interactive program determines what will be presented to a particular viewer. Initially, the Playpack is stored locally (F) on the Display Device. If other Playpacks have been installed on the Display Device prior to this Playpack, then viewer Meta-data is extracted from the prior Playpack(s) and incorporated into this one (G). Based on all the available Meta-data, the Playpack can then determine the most desirable Media Items to display for a particular Viewer on the Display Device (H). When those Media Items are displayed, the viewer's response(s) are recorded, and used to extract generalized Meta-data about the viewer's likes and dislikes (I and J). This viewer Meta-data is fed back into the Playpack, and used to refine Media Item selection criteria for the future.

### Determining the Most Desirable Media Items.

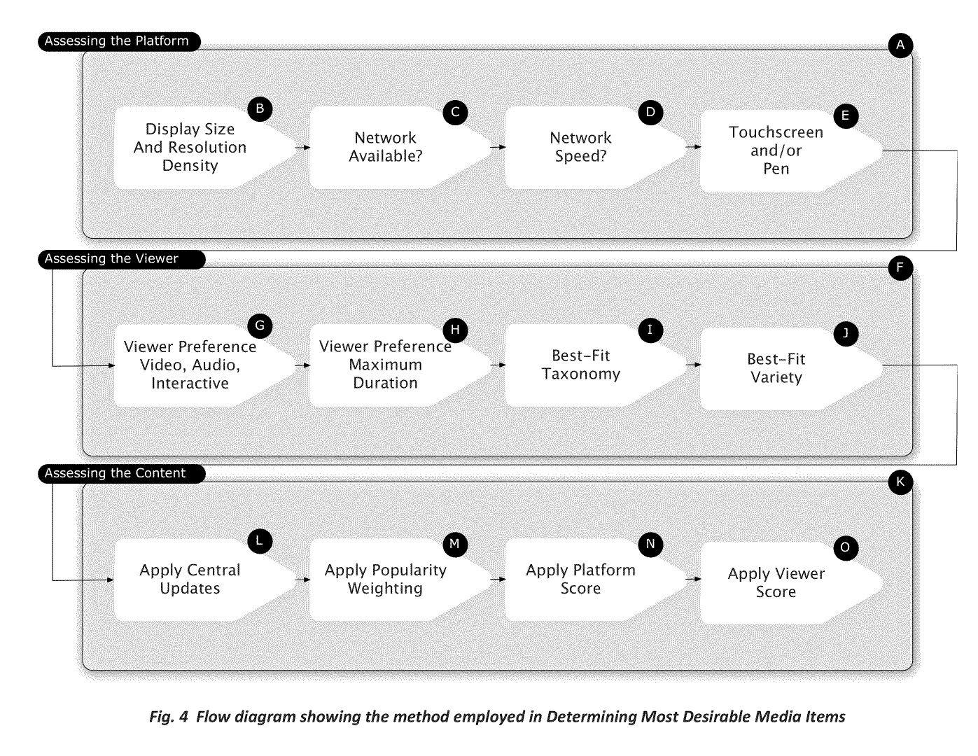

FIG. 4 Shows a method employed for identifying the most desirable Media Item(s) for the current viewer and resources.

FIG. 4 is an expanded view of Step H within FIG. 3 (“Determining Most Desirable Media Items”). For each Media Item in a given Playpack, and at a particular time, and for a particular viewer the goal is establish a “score” which can be used to rank the Media Items. The Media Items with the highest “score” are presented to the viewer. Following presentation of a Media Item from within a Playpack, the score of each Media Item is revised. The next Media Item to be presented to the viewer is the one with the next highest score.

Alternatively, the methods for determining the most desirable media item(s) may be constructed as a media item recommendation engine. Such a recommendation engine may involve developing a uniform description of attributes for media items (e.g. in a library). In particular the uniform description methodology would facilitate describing the items according to how a child might see the item. Such a uniform description approach may be called “a taxonomy,” because it aims to develop a formal language uniquely describing the elements of meaning for media items to be accessed through a Playpack. For example, an item might be described with the terms “game,” “mathematics,” and “counting.” If a child likes an item in this grouping, then the probability is high that the child will like another item in that same grouping.

### (a) Assessing the Platform.

The first level of assessment for Media Items involves the Display Device Platform, or the physical attributes of the Display Device currently in use by the Viewer (A). Each Display Device has one primary display, where digital media is presented to the viewer. Depending on the physical size and quality of the device, its display may be small, medium, large, or extra-large. Again, depending on the physical attributes of the device, the display may be low, medium, high, or extra-high resolution density. By combining these two attributes, a score is established as follows:

| “Screen Score” | | Medium | | Extra-High |
|---|---|---|---|---|
| (SS) | Low density | density | High density | Density |
| Small size | 1 | 2 | 3 | 4 |
| Medium size | 2 | 2 | 3 | 4 |
| Large size | 3 | 3 | 4 | 5 |
| Extra-Large | 4 | 4 | 5 | 6 |
| size | | | | |

Turning to whether the Display Device has an available network connection (C), this results in a “Network Factor” (NF) of either 1 for available, or 0 for unavailable.

If there is an available network connection, the network speed may be designed as slow, medium, fast, or extra-fast, for example. Scores for these network speeds (D), together with common examples for each are given below.

| “Network Speed Score” | | |
|---|---|---|
| (NSS) | Name | Example |
| 1 | Slow | CDMA |
| 2 | Medium | 3G |
| 3 | Fast | 4G/Wifi |
| 4 | Extra-Fast | Wired (10-100 GB) |

The final attribute considered for the Display Platform is whether it has a touch-screen, and whether that touch-screen responds to a pen or stylus (E). This attribute may have one of three values, either 0 for no touch-screen, 1 for a touch-screen, and 2 for a stylus touch-screen. This attribute is the Touch Screen factor (TS).

At the conclusion of the Assessing the Platform phase, the following attributes are established within the local copy of the Playpack:
Screen Score (SS) Representative of the “cost” of displaying data, where a low score indicates that displayed images and video are smaller and less dense, and a high score indicates that displayed images are larger and more dense;
Network Factor (NF) Representative of whether there is a network connection currently available;
Network Speed (NSS) Representative of the network connection's capacity, if available; and
Touch Screen (TS) Representative of whether a touch-screen is available.

### (b) Assessing the Viewer.

The next phase is to develop a numerical description of the Viewer currently viewing the Playpack (F). This aspect of a Playpack involves pattern recognition over time. Thus, if a Viewer is new to the system, very little is known about the Viewer's likes or dislikes (G). Observing patterns over time is preferable to using the Viewer's self-evaluation, since self-evaluation (or evaluation by a Parent, if the Viewer is a child), is highly subjective, and error prone. As a Viewer interacts with the Display Device, however, patterns emerge.

In order to determine whether a particular Media Item that is accessible via a Playpack is desirable for a particular Viewer at a given time, it is first important to understand the method for evaluating the Viewer over time. Once it is understood how a Viewer is evaluated, then we can discuss how to apply that data to predict whether a Media Item is desirable to the Viewer.

The most basic Viewer pattern is whether a Viewer prefers visual, auditory, or kinesthetic information presentation. Repeatedly choosing one type of Media Item, as classed by video, audio, and interactive, reveals a preference pattern. Thus, each Media Item in a Playpack receives a presentation attribute (PRi) when the Playpack is created. This presentation factor is one of:

| Factor | PRi Value |
|---|---|
| Visual | 1 |
| Auditory | 2 |
| Kinesthetic | 3 |

A Viewer's Presentation preference is recorded as a number, between 1 and 3, and id updated with every viewing of a new Media Item. To normalize the effect of viewing one presentation type over another, each Media Item's impact on a Viewer's score is adjusted according to its relative frequency in the Playpack. Thus, each time a Viewer chooses a Media Item to view, that Viewer's score in the Playpack is adjusted as follows:

PR=PR+(PRi*(m/n)) (1)

Where PR is the Presentation Preference score for a particular Viewer; PRi is the value for the currently chosen Media Item, given in the table above; m is the number of Media Items in this Playpack with the same PRi value as the one being viewed; and n is the total number of items in this Playpack.

Applying this calculation repeatedly will cause the Viewer's PR value (representative of that Viewer's preference for Visual, Auditory, or Kinesthetic presentation) to drift closer to 1, 2, or 3. Values between 0 and 1 indicate a preference for Visual presentation; between 1.01 and 2 indicate a preference for auditory presentation, and between 2.02 and 3 a preference for kinesthetic presentation.

Next, the Viewer's preference for presentation length is considered (H). If the Media Item's PR is 3, then this factor is always zero—indicating that it has no impact. Otherwise, the Viewer's Duration Score is calculated, at the end of viewing each Media Item, as:

D=((5*D)+Di)/6 (2)

Where D is the Duration “score” for this user, and Di is the number of seconds which the Viewer spent watching this Media Item. Applied repeatedly, this score will drift toward the average time this Viewer can remain focused on a particular Media Item.

Next, the Viewer's preferences for Subject Matter Category are evaluated over time (I). Subject Matter Category means, in broad terms, what type of subject matter is presented in a particular Media Item. For example, if a Media Item presents information about volcanoes, that that information is recorded when the Playpack is created. It is typical that a given Media Item will present information that belongs to more than one category. For example, a Media Item might present information about volcanoes, but might focus on the geology of how they are created, instead of the geography of where they are located; or it may equally treat both. Further, the Media Item may present information about underwater volcanoes, or focus on landmass volcanoes, or volcanoes on non-terrestrial bodies such as moons of other planets. It is important to develop organizing principles around the type of subject matter presented, but to do so from the perspective of the Viewer (as opposed to an expert in the field).

The present invention employs a “taxonomy” or set of semantic categories, oriented toward a particular viewership, to classify the subject matter within a particular Media Item. What is relevant to the present invention is the application of this methodology within the context of a Playpack. For purposes of this disclosure, it is presumed that there exists a uniform taxonomy, which describes in unambiguous terms the subject matter presented in commonly available Media Items. It is assumed that the taxonomy is flexible (meaning it can be altered), and extensible (meaning it can be expanded with new terms).

The taxonomy used in these methods and systems of ordering Playpack accessible media items, is from contemporary approaches toward grouping content in that the current taxonomy references “meaning,” of media items, whereas other system merely extract easily observable external attributes. For example, contemporary systems might extract external attributes such as “author,” “brand,” “main character,” “length,” or “television channel.” The current taxonomy is used to represent “internal” categories such as “funny,” “community-building,” “multi-cultural”, and the like. Pairing the “internal” (i.e. subjective) attributes with the “external” (i.e. readily-observable, objective) attributes, the strength of associations between items within a grouping should soar. This should lead to predictions with high degrees of confidence about what will engage a child when applied to what has already engaged them.

It is further assumed that each “leaf node” in this taxonomy is assigned a unique identifier, such as a number. Each Viewer accumulates a list of these unique identifiers (“Taxonomy Hit List” or “THL”), and a count associated with each. Each Media Item in the Playpack has (at Playpack creation) a list of Taxonomy Identifiers (“Taxonomy Identifier List” or “TIL”) that identify the subject matter of that Media Item. Every time a Viewer views a Media Item, the Viewer's THL is updated as follows:

```
for each TIL[i]
      if TIL[i].identifier exists in THL then
            update THL[i] entry in THL
      else
            add TIL[i] entry to THL
      end
end
```

“Update THL entry” is defined as:

```
if Media Type == “Kinesthetic”) then
      COUNT = COUNT + 1
else
      if Viewing Duration < (0.5 * Media Item Duration) then
            if COUNT > 0 then
                  COUNT = | COUNT − 1 |
            end
      else
            COUNT = COUNT + 1
      end
end
```

“Add TIL entry” is defined as:

```
if Media Type == “Kinesthetic”) then
      add TIL to THL with COUNT = 1
else
      if Viewing Duration > (0.5 * Media Item Duration) then
            Add TIL to THL with COUNT = 1
      end
end
```

As a further refinement to this method, the THL can also include a “last updated” timestamp for each entry. Each time an entry is updated, the current timestamp replaces the previous one for that entry, indicating when the last update was made for each entry. However, prior to discarding the previous timestamp, it is employed as follows in the “Update THL entry” above as follows:

```
DECAY_FACTOR = ( now( ) − Previous Timestamp ) /
DECAY_THRESHHOLD
if Media Type == “Kinesthetic”) then
      COUNT = ( COUNT * DECAY_FACTOR ) + 1
else
      if Viewing Duration < (0.5 * Media Item Duration) then
            if COUNT > 0 then
                  COUNT = | COUNT − 1 |
            end
      else
            COUNT = ( COUNT * DECAY_FACTOR) + 1
      end
end
```

Having examined how the THL is created and updated, we can turn to how the THL is used in determining the desirability of a Media Item prior to viewing. A Media Item is given a “Taxonomy Score” or (TS) according to this method:

```
TAXONOMY_SCORE = 0
for each TIL[i]
      if TIL[i].identifier exists in THL then
            TAXONOMY_SCORE = TAXONOMY_SCORE +
            THL[x].value
      end
end
```

Given this method, the higher the TS, the more likely that this Media Item is to be desirable to this Viewer.

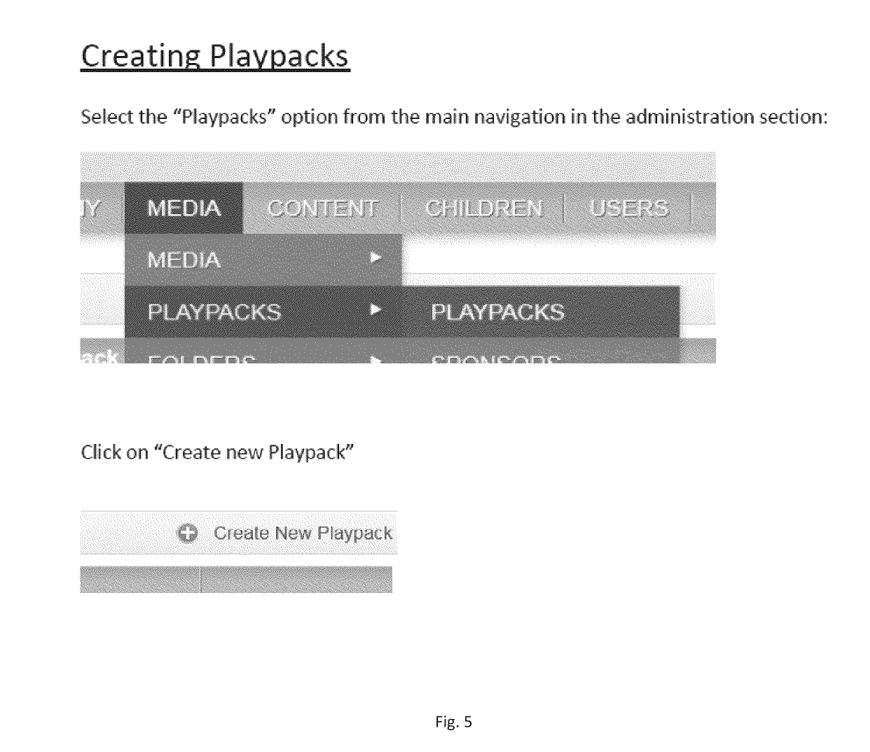

The final consideration in this phase is variety, or whether the Media Items in this Playpack have been repeatedly viewed by this Viewer so as to become stale and therefore undesirable. It is important to note that age plays an important role in tolerance to repeated viewing. The FIG. 5 shows an example of tolerance for repeated viewing of a particular Media Item for given Viewer ages.

Thus, a Playpack needs to track how often and how recently a particular Viewer has viewed a given Media Item. This is expressed, for each Media Item in a Playpack, for each Viewer:

| Attribute Name | Attribute Description |
|---|---|
| VarietyLV | The timestamp of when this Viewer last |
| | viewed this Media Item |
| VarietyNV | The count of the number of times this |
| | Viewer has ever viewed this Media Item |
| VarietyMTBV | The Mean Time Between Views for this |
| | Viewer and this Media Item (calculated |
| | using VarietyLV and VarietyNV) |

### (c) Assessing the Content.

Now we move to the final phase of this part of the method. Once we have assembled the above metrics for the first two phases of this method, we can apply those metrics to the content in this Playpack to achieve a ranked list of Media Items, ordered by desirability for this Viewer at this time (K).

The first step of this phase is to apply any central updates (L) to the Playpack. Each Playpack contains one or more Media Items. Those Media Items are augmented with new Media Items from time to time. For example, a particular Playpack might initially be transmitted to all Display Devices with ten Media Items in it. Each week for four weeks, an additional two Media Items may be added to the Playpack. At the end of four weeks, the Playpack contains eighteen Media Items. It is important to note that Media Items are never removed from a Playpack via central updates. Central Updates only ever add Media Items. However, a particular Display Device may remove one or more Media Items from a Playpack to recover storage space. The Display Device would remove least-desirable Media Items first (according to the criteria established in this section of the methodology).

The remaining steps in the method require iteration over each Media Item in the Playpack. The goal of repeated iterations is to order the Media Items in the Playpack according to desirability. The first iteration (M) applies a centrally-determined “Popularity Weighting” (“PW”). PW is an integer from 0 to 100, which is applied first at Playpack creation, and then again after each addition of one or more Media Items to a Playpack. It gives the author of the Playpack a means to order the Media Items within the Playpack. Media Items with a lower weight number are less desirable overall, and ones with higher are more desirable. Media Items with identical weightings are deemed equally desirable overall. For example, in the previous example of a Playpack with Media Items about volcanoes, a recent volcano eruption might result in new Media Items becoming available, which are of immediate interest to all viewers because of the current nature of the Media Item. Those Media Items would receive a higher PW by the Playpack author when the Playpack is updated.

The second iteration (N) is to apply the Platform Score to the Media Items in the Playpack. To begin with, each Media Item will either have a “Local” copy of the associated data, or an “Online” copy, or both. If the Platform currently has no network connection (NF), then only Media Items with a “Local” copy of the associated data is eligible for ranking. All other Media Items are considered non-existent for ranking purposes.

Each Media Item, whether “Local” or “Online,” will have one or more versions of the associated data, formatted according to various encoding techniques well known in computing. Each encoding technique results in a version of the associated data that is optimized either for higher display quality, or for smaller transmission size. For example, a single video may be encoded and made available in three encoding formats: low quality, medium-quality, and high quality. These three encoded versions would be, for example, respectively, fast-transmission-speed, medium-transmission-speed, and slow-transmission-speed. As quality improves, transmission time increases, and vice-versa.

Here is an example of a few video encoding techniques, ranked by quality (low to high) and transmission speed (fast to slow):

| Video Format | Value |
|---|---|
| FORMAT_MP4_176×174_BR05 | 1 |
| FORMAT_MP4_176×174_BR2 | 2 |
| FORMAT_FLV_400×240_240p | 3 |
| FORMAT_FLV_480×270_270p | 4 |
| FORMAT_MP4_640×360_360p | 5 |
| FORMAT_MP4_1280×720_720p | 6 |

This table is applied as follows:

```
for each MEDIA_ITEM[i]
      if( MEDIA_ITEM[i] is Local )
            QUALITY_SCORE = 6
      else
            switch ( NSS ) :
            case 4:
                  QUALITY_SCORE = max( video format value )
                  break
            case 3:
                  QUALITY_SCORE = max( video format value
                              for values less than 6 )
                  break
            case 2:
                  QUALITY_SCORE = max( video format value
                              for values less than 5 )
                  break
            case 1:
                  QUALITY_SCORE = max( video format value
                              for values less than 3 )
                  break
            default:
                  QUALITY_SCORE = 0
                  break
            end
      end
      MEDIA_ITEM[i].quality_score =
            QUALITY_SCORE * ( 1 / SS )
end
```

Any Media Items with a “Quality Score” of zero are treated as non-existent for purposes of establishing desirability.

If a Media Item is Interactive, as opposed to video or audio, then if the Display Device does not have a touch-screen, then that Media Item is considered non-existent for purposes of establishing desirability.

All Media Items with non-zero Quality Scores are ordered, highest score to lowest, where the highest are the most desirable, and the lowest are least desirable for this Viewer at this time.

Taking the result of the foregoing, an ordered list of Media Items, sorted from most to least desirable, we proceed to the final phase: applying the Viewer Score (O).

Calculating the Taxonomy Score for each Media Item is discussed above. That score is now used to order the list of Media Items according to the “closeness” of fit. A higher Taxonomy Score indicates a “closer fit” relative to the other Media Items in the Playpack. That sorted list is then re-ordered according to one or more “scatter” algorithms to reduce repetition, according to Viewer tolerance for repetition as discussed above.

The result of this method is an ordered list of Media Items in this Playpack, representative of the likelihood of each Media Item being desirable to this Viewer at this time. The Display Device then presents these Media Items in order of desirability to the Viewer.

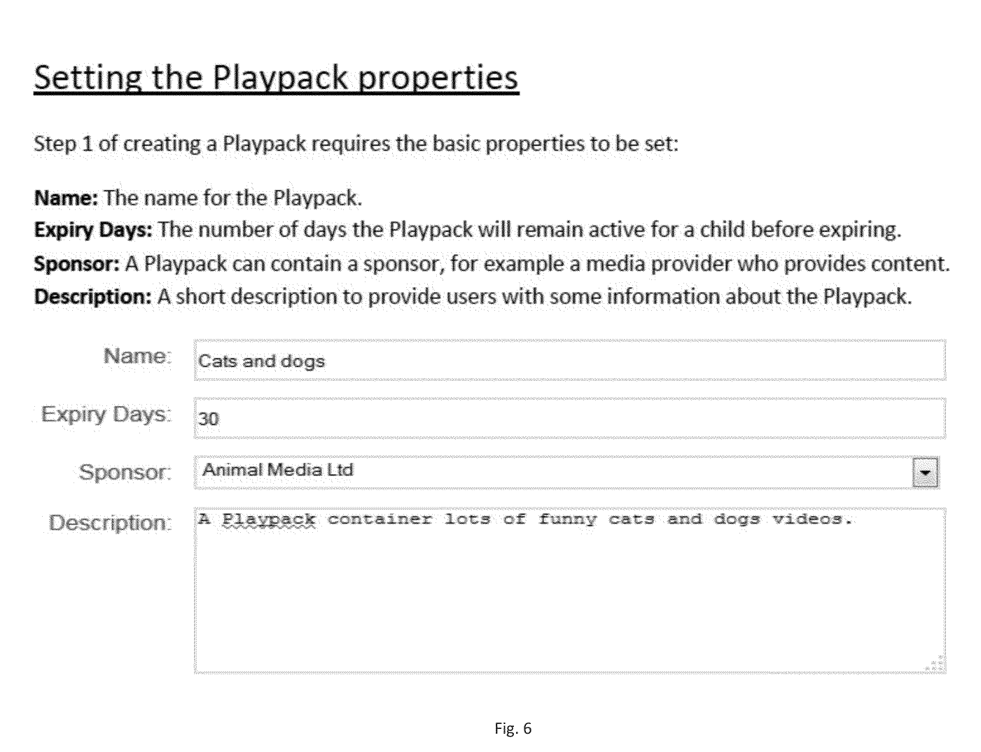

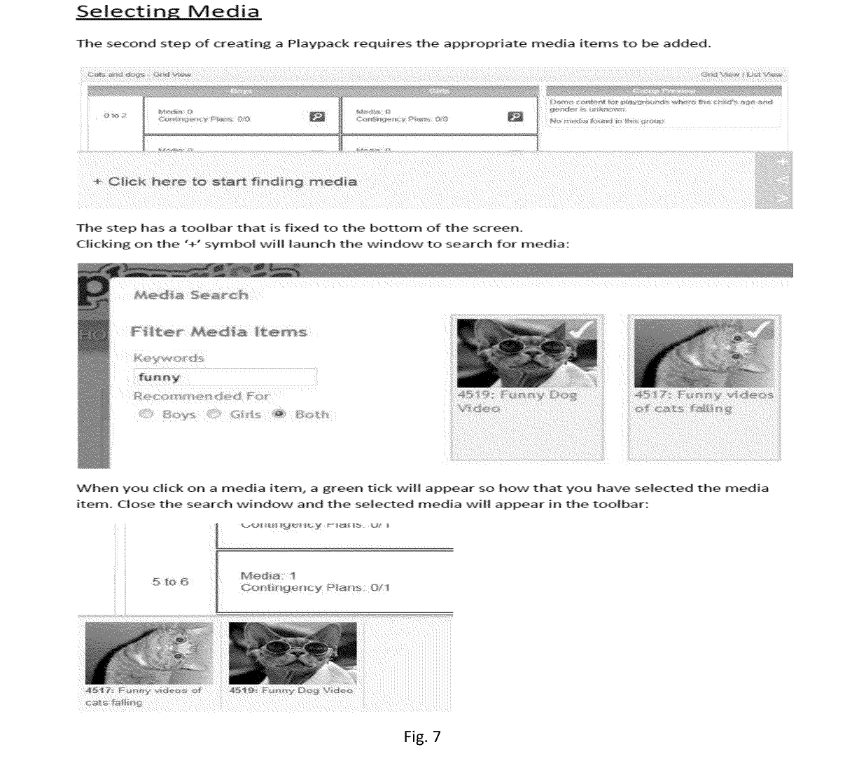

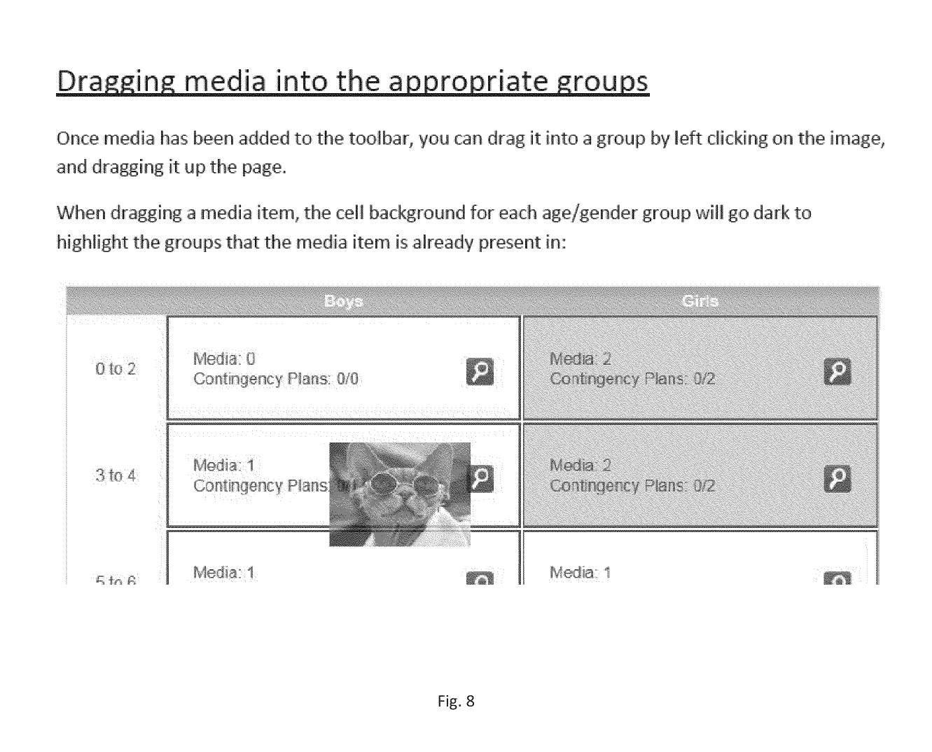

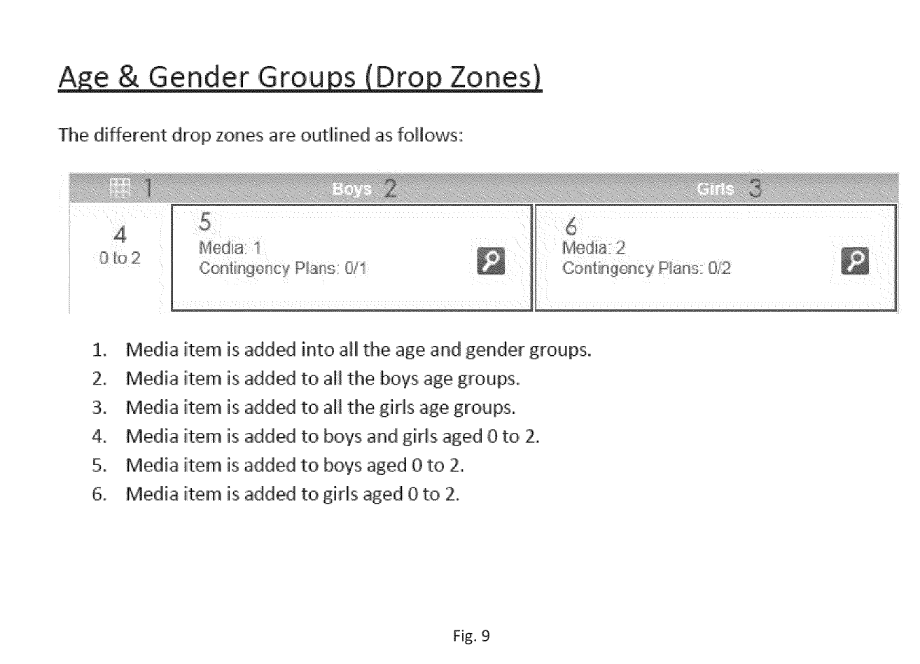

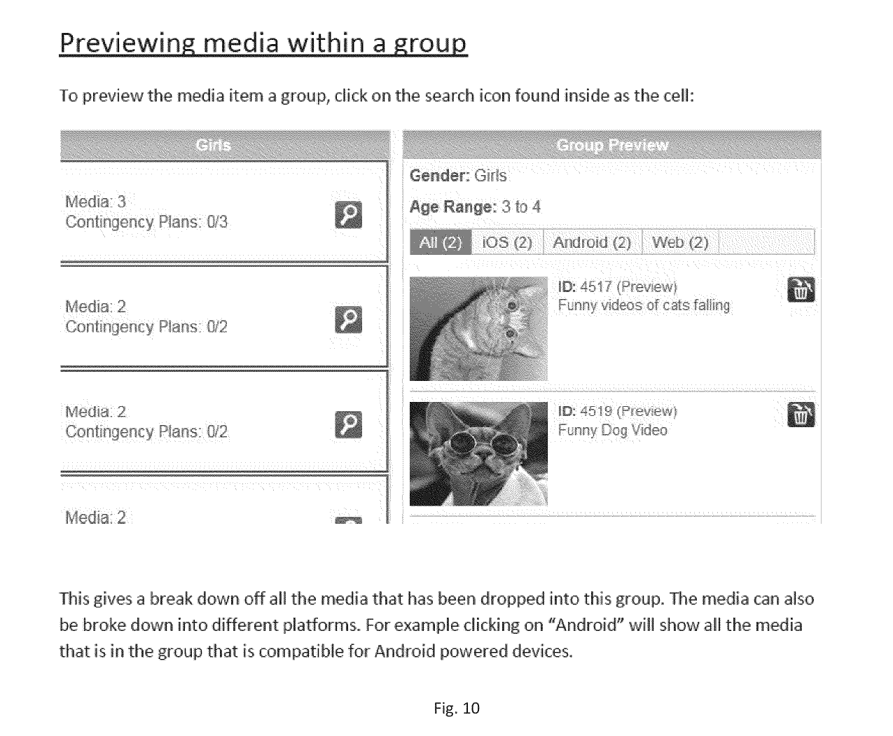

FIGS. 5-10 depict various steps in creating a Playpack. FIG. 5 depicts creating a Playpack. FIG. 6 depicts setting Playpack properties. FIG. 7 depicts selecting media. FIG. 8 depicts aligning (e.g. dragging) media into appropriate groups. FIG. 9 depicts age and gender drop zones. FIG. 10 depicts previewing media within a group.

### Data Gathering Mechanism for Safe Child Behavior Monitoring

Normally, gathering data about usage of a particular individual involves assigning that individual a Persistent Unique Identifier (PUI) (typically a number), and organizing all their usage under that single number. When analyzing the individual's behavior, all the data identified by their PUI is assembled and compared. This is not possible within the law, when children are involved, because the law proscribes a single, system-wide, persistent identifier for a child-user when it can be used to identify behavior or identify the specific child.

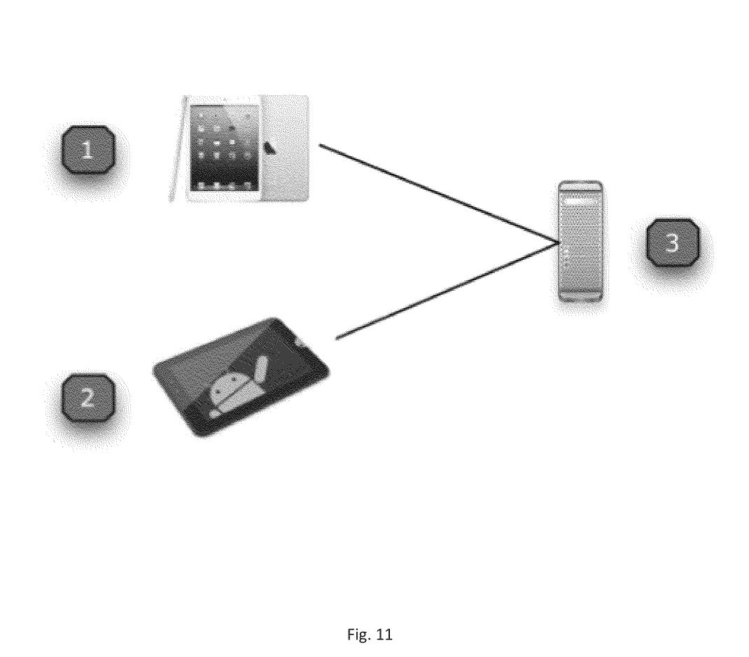

FIG. 11 shows a typical configuration of Remote Mobile Devices (1 & 2) connected through a network to a Central Server (3). In this configuration, users install and operate application software on the Remote Mobile Device.

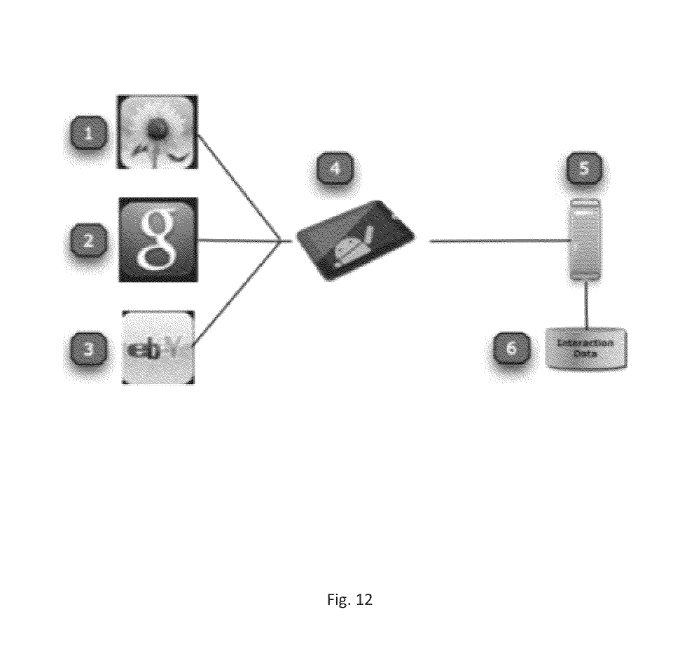

FIG. 12 shows the typical configuration for a single Remote Mobile Device (4) connected through the network to a Central Server (5). In this configuration, the user has installed three applications (1,2,3). These applications operate on the device performing various functions for the user, such as taking and displaying photos, searching the Internet for information, or connecting to commerce sites to buy and sell merchandise. As a by-product of using these applications, the applications can record and store information about how the application was used, and what interactions uses have with the application. This information can contain time-stamps, to show the exact sequence in which the user interactions transpired. This data, data about the user interaction with applications on the device, is transmitted to a Central Server (5), which stores it in a central database (6).

Each Remote Mobile Device contains a unique identifying number, accessible from within applications on that device.

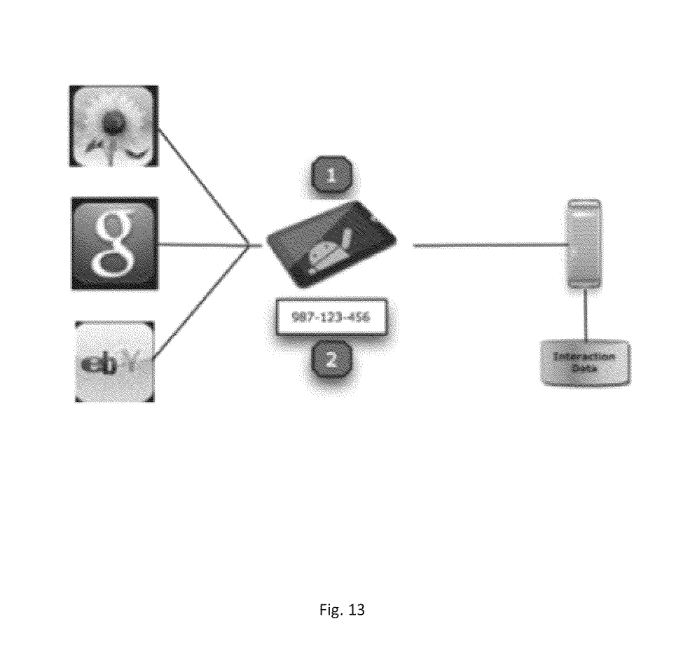

FIG. 13 shows the relationship between the Device-Specific Code (2) to the Remote Mobile Device (1). In some cases, the Device-Specific Code is part of the firmware (that is, part of hardware of the Remote Mobile Device). In other cases, it is configured as part of the Operating System, and can be changed when the device is reset.

When an adult is using the Remote Mobile Device, there is no restriction on using the Device-Specific Code to identify the user. This is a straight-forward way for software manufacturers to assign an identifying number to usage data. When it is possible that a child is using the Remote Mobile Device, software manufacturers must not use the Device-Specific Code, under the law.

As FIG. 13 shows, however, all the usage data from multiple applications is stored in a single location, under a single Device-Specific Code. This enables analysis of the usage data. However, it also enables detecting relationships between which children used different applications. Detecting usage between applications, under the law, is profiling the behavior of a child, which is proscribed.

Advertising and promotion, which generate revenue for a software manufacturer, enable the manufacturer to furnish software to families and children free of charge (to them). The least annoying and most effect form of advertising and promotion is “push” or “targeted” messaging.

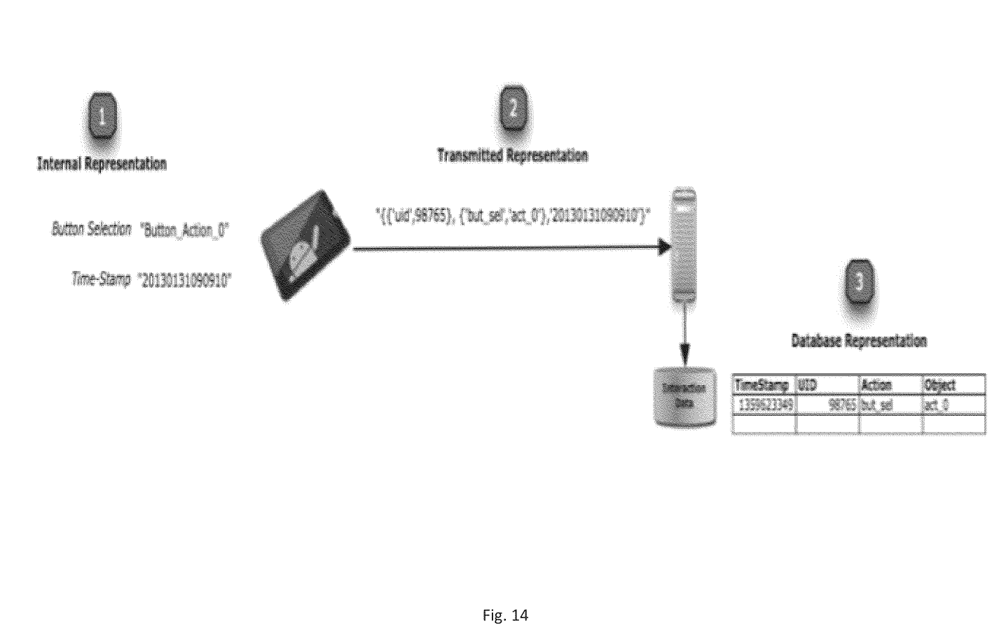

FIG. 14 shows a configuration where multiple users of a single application on a plurality of Remote Mobile Devices report usage data to a single database. If the Device-Specific Code is used to identify the usage data, then advertisers or promoters can target the plurality of Remote Mobile Devices for messaging. This is valuable for advertisers and promoters, because it narrows the amount of messaging required to reach users with known interest in the application. For example, if usage information is gathered from a photo taking-and-displaying application, and organized according to the Device-Specific Code, then an advertiser or promoter could request that a message announcing availability of a new photo enhancement or printing service to all the users of the photo taking-and-displaying application. This is permitted under the law.

If, however, location and time-stamp information about each photo is included in the usage data, then it is possible to infer behavior from the locations and time of the photos as a group. That information, indicia of behavior, is not permitted to be extracted from the usage data. Thus, gathering usage data which makes it possible to connect specific behavior to a specific device becomes unlawful; even if that data is never used to establish such connections. This becomes more complex, when considering whether the software manufacturer (and owner of the collected data) shares the data for analysis with third-party advertisers and promoters. Even if the third-party advertisers and promoters never extract analysis which connects behavior to specific Remote Mobile Devices, the possibility of doing so makes the sharing of the usage data unlawful. For this reason, it is desirable to re-factor the usage data in such a way as to make it lawful to (a) use within the owner's business, and (b) share with third-party advertisers and promoters, and (c) prevent accidental disclosure.

Data Storage Mechanism. Typically, usage data is transmitted simultaneously as use occurs. For example, if a user selects one of three options on a particular screen on a Remote Mobile Device, then at the same time that the software acts on the selection, it also “locally” (i.e. on the Remote Mobile Device itself) stores the fact of the selection, with a time-stamp. Typically, storing a new entry triggers an asynchronous task on the Remote Mobile Device to transmit all locally stored data to the central server. If that transmission succeeds, the data is removed from the local data storage. If the transmission fails (e.g. in the case of a temporary network outage), then the data is left in the local data storage for transmission when the network becomes available again. This technique is well understood in the industry, and is known as “store-and-forward” messaging.

When the message is received by the central server, it is translated into data which can be stored in a central database on the central server. Again, this technique is well understood in the industry, and not unique to this disclosure. For example, information may be transmitted in “JSON” format (a standard for data transmission in the industry), then marshaled into internal representations of the same data within the server, and then stored into a central database as a third representation of the same data. Transmitting this data between the Remote Mobile Device and the central server is typically accomplished on an “encrypted socket.” That, again, is well understood in the industry, and not uniquely part of this disclosure. However, by encrypting the message prior to transmission and decrypting it after reception, unintentional interception and use of the data is significantly reduced.

This disclosure addresses the manner in which the data is represented within the database on the central server.

FIG. 14 shows how usage data is collected on the Remote Mobile Device (1). It is gathered using “internal” representations of the data, appropriate to the Remote Mobile Device. It is then translated to a “network” representation of the data, typically “JSON” or equivalent standard (2). When the central server receives the usage data, it is then translated into a “database” representation of the data, appropriate for storage in a database on that server (3). For clarity, again, all these steps are well understood in the industry, and not unique to this disclosure.

This disclosure addresses how to “anonymize” this usage data such that it can be used for analysis on the central server, but comply with the laws restricting children's usage data.

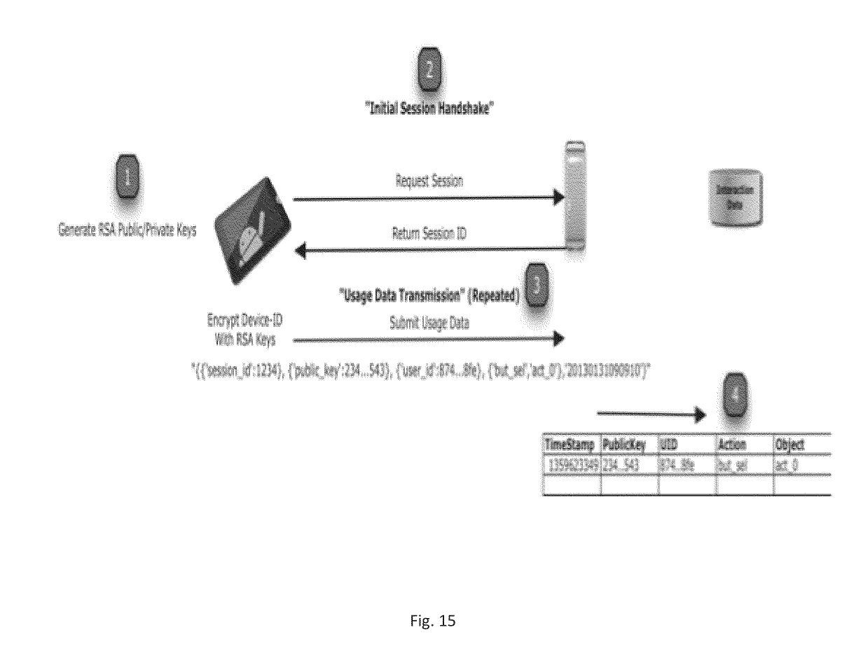

FIG. 15 shows the process of preparing for and transmitting an “anonymized” version of the usage data. Here, each individual action is shown as a separate transmission, but an alternate embodiment of the disclosure might include combining start and end timestamps for each action in a single transmission and database record.

During app installation, RSA Public and Private Keys are automatically generated (1) for this application and this Remote Mobile Device. RSA keys are well understood in the industry, and in the interest of brevity, we do not review the details of that technology here. During the initial network transaction with the central server, the Remote Mobile Device submits a request for a new SessionID (2). The SessionID is a unique identifier for a particular user over a particular time-span, and is well understood in the industry. The central server responds with a valid SessionID, (3) which enables the Remote Mobile Device to communicate with the central server without re-validating the Remote credentials (e.g. user-name and password) with each message. The Remote Mobile Device then uses its RSA private key to encrypt the UserID from the Remote Mobile Device into the transmitted usage data packets (4). And these usage data packets are stored in the database as transmitted.

An alternative embodiment of the disclosure might include applying store-and-forward techniques to transmission of the usage data.

The advantage of this disclosure is that it makes it impossible at the central server to determine which usage data relates to which specific user. Even if the data from the central server were accidentally disclosed or intentionally sold to a third party, the system maintains no link between public key and a specific user. However, the data can still be used to advantage on the central server by tracking that one particular user exhibited a specific behavior pattern. Again, knowing which user is impossible, but knowing that it was a single user simple. This simplicity makes it possible to create reports on aggregate usage patterns, showing, for example, number of unique users per day, average number of sessions per user per day, and average session duration per user per day.

The present embodiment depicts using the RSA public key record itself as the identifying element. An alternative embodiment might include using a separately-generated (unrelated) identification element during app installation on the Remote Mobile Device. This would further separate the identity of the user from the usage data in the central database, but this level adds complexity for modest improvement in anonymity.

### Using and Analyzing the Data.

There are three Use Cases for analyzing the data in the central server's database. These are detailed below.

Use Case #1: Granting and Revoking Verified Parental Consent (VPC).

The law contemplates that parents should be able to grant permission for software providers to gather information with Verified Parental Consent. The law also requires that a company prove that it has deleted all information about their child if they make such a request. The key trouble here is that deleting all data also deletes all the “anonymized” information, which can greatly impair the ability to detect usage trends over time.

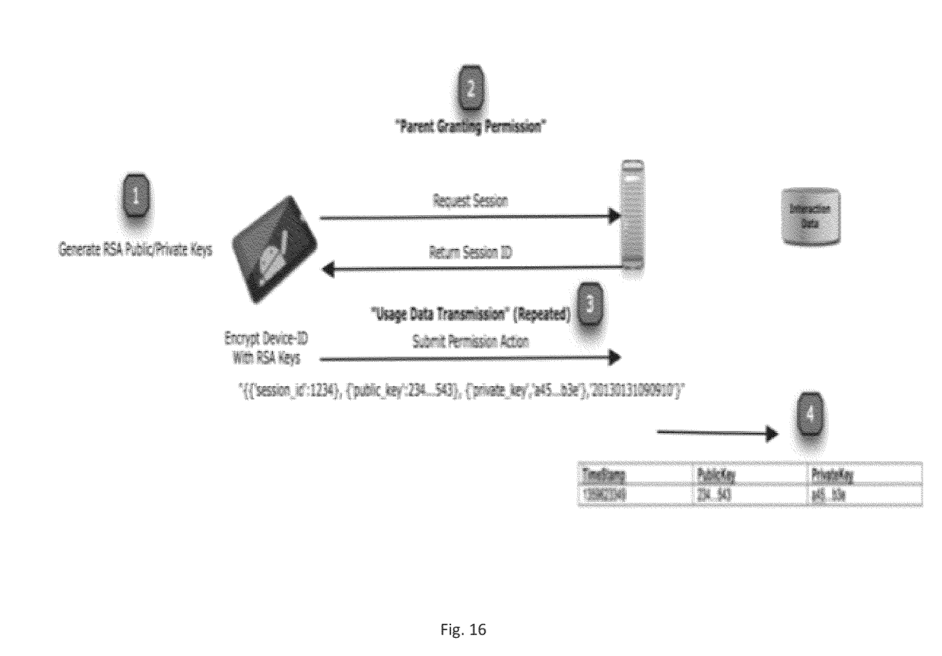

FIG. 16 shows an embodiment of the mechanism for granting parental consent within the disclosure. Granting consent consists of transmitting the application-specific RSA Private Key (1) to the central server (3), which stores it in a database (4), separate from usage data. By applying the Private Key to all usage data records indexed by the Public Key, the system can locate the unique UserID which generated the record.

One example of using this information is in personalizing a child's experience based on past observed behaviors. If a child exhibits (through the system) an interest in automobiles, the system can rank and select other, related materials online and offline for that child which are related to automobiles. At the same time, the overall contribution of this data record to the system is that a child (i.e. one of the population of all, un-identified children) exhibited an interest in automobiles.

By repeating the flow of FIG. 16, but instead requesting de-authorization (i.e. removing consent), the Private Key is removed from the database, and all information linking the Public Key to a specific UserID within the central server is lost instantly.

Two benefits stem from this approach. First, data can be collected from the first instance when a particular child interacts with the system. And later, if a parent subsequently agrees to allow access to the personalized data through VPC, all data from the very first interaction with the child is then available to the system.

Second, parents can be assured that all data connected to their child is “disconnected” from their child simply by either (a) requesting that the Private Key be deleted from the central server, or (b) re-installing on the Remote Mobile Device, thus generating a new Public/Private Key pair. In practice, this is far more reliably solution than trusting the operator of the central server to track down and delete all data related to a specific child. On the one hand, that is a challenging task. On the other hand, it involves destroying usage data which is usually quite valuable to the operator of the central server. Thus, from a practical standpoint, this disclosure offers a far-superior protection for parents to be sure that their child's data is eliminated.

The embodiment described here shows a simple transmission of the RSA Private Key to the central server, and storage of the RSA Private Key in “plain text.” One or more alternate embodiments of the disclosure might include using one or more well-understood techniques for obfuscating plain text transmission and storage, such as “hashing.” This would limit the possibility of intercepting the Private Key during the initial transmission. Another alternative embodiment might involve regeneration and re-transmission of RSA Public/Private Keys on a frequent (e.g. daily) basis. This would protect against being able to infer the identity of a particular child's behaviors simply by observing a pattern associated with the Public Key alone. Since, in this alternative embodiment, the Public Key changes frequently, behaviors which occur within the frequency period could be associated by this means. However, as long as the parent has furnished the Private Keys as the Public Key changes, then the actual identity can be determined, and patterns can be observed.

### “Push” Messaging Mechanism

In practice, it is common to want to “target” specific advertising and promotional messages to specific individuals based on known demographics or affinities. This is true of children especially, since children tend to have reduced attention, and will dismiss a cluster of messages based on reviewing the first message in a cluster.

The law currently permits advertising and promotion to be “targeted” at groups of children based on common attributes, such as age, gender, geography. It is currently unlawful to “target” advertisement and promotion to children based at all on their observed behaviors. Because of this, advertisers and promoters must resort to broad, category-based messaging, which is often too general to communicate well with children. When this communication is chiefly for the benefit of the advertiser or promoter, as a matter of public policy, this is not a large concern. However, when the communication can benefit the child, it becomes important to communicate effectively with a specific child.

As an example, assume that a child engages with a particular application on a Remote Mobile Device. Assume further that the child spends more than a certain amount of time exhibiting a particular behavior, like affinity for trucks. A promoter of a particular toy truck might want to offer that child a discount on the toy as incentive. This could come in the form of a coupon, offered electronically; which is a well-understood technique in the industry. Directly offering the promotional coupon to the child based on behavior is unlawful, because it is “targeting” based on observed behavior.

The present disclosure separates the task of directly communicating with a child based on observed behaviors into two parts, which (because it restores parent control of the messaging) makes the activity lawful.

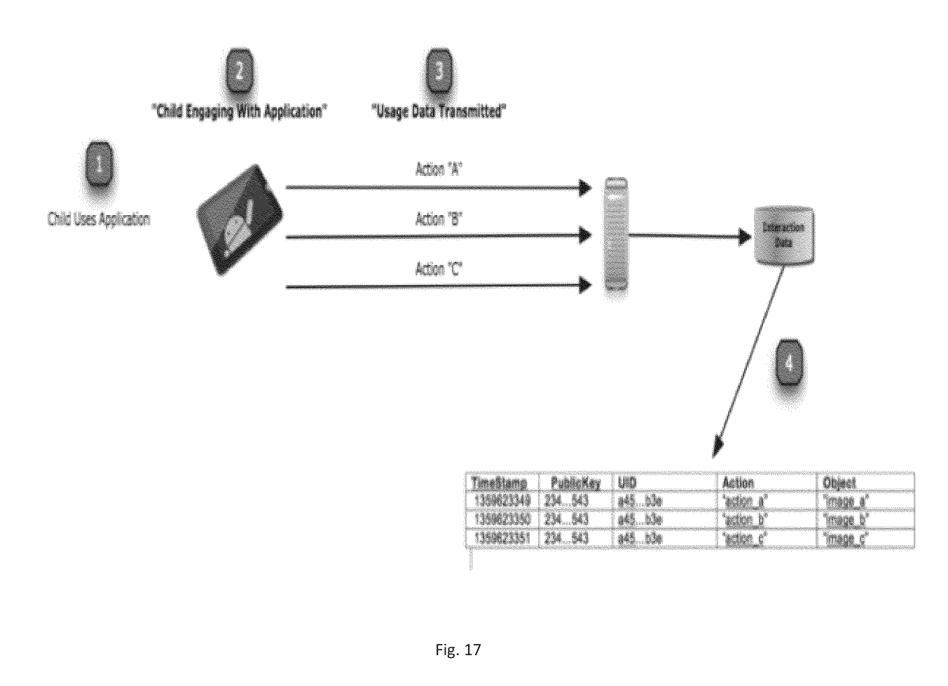

FIG. 17 shows storing the usage data (how the child interacts with a specific application) being transmitted to a central server. It is “anonymized” according to the foregoing description of the disclosure. The usage data is shown stored as “rows” in a central database, but alternative embodiments might store it other ways, such as flat files. The usage data is indexed by the PublicKey, which in the present embodiment is generated by each application which is installed on the Remote Mobile Device. In this way, the fact that a single child exhibited the behavior “action_a,” “action_b,” and “action_c” in that order is obvious from searching the data. However, the identity of that child is impossible to know (within the encryption limitations of RSA) without Parental Consent.

Assuming for illustrative purposes that a third-party promoter wanted to communicate with all the children who are exhibiting the behavior “action_a,” “action_b,” then “action_c” in any order. Further assume that the communication was to furnish them with a discount to try or purchase a new toy available online or in retail stores. One alternative would be for the third-party promoter to communicate with all the children who are transmitting usage data to the central server. The disadvantage of this is that message would have to be generalized to address a broader population, with more diverse interests. And more likely, the message would need to be combined with other messages, which has the effect of “burying” the appropriate message which is (potentially) of interest to a specific child. A second alternative is to develop a list of all children exhibiting the desired behavior, and message them. This being unlawful is un-workable.

The present disclosure addresses this gap by “pushing” highly-targeted messages to the “edge of the server,” and then enabling parents to “pull” the desired ones for their children.

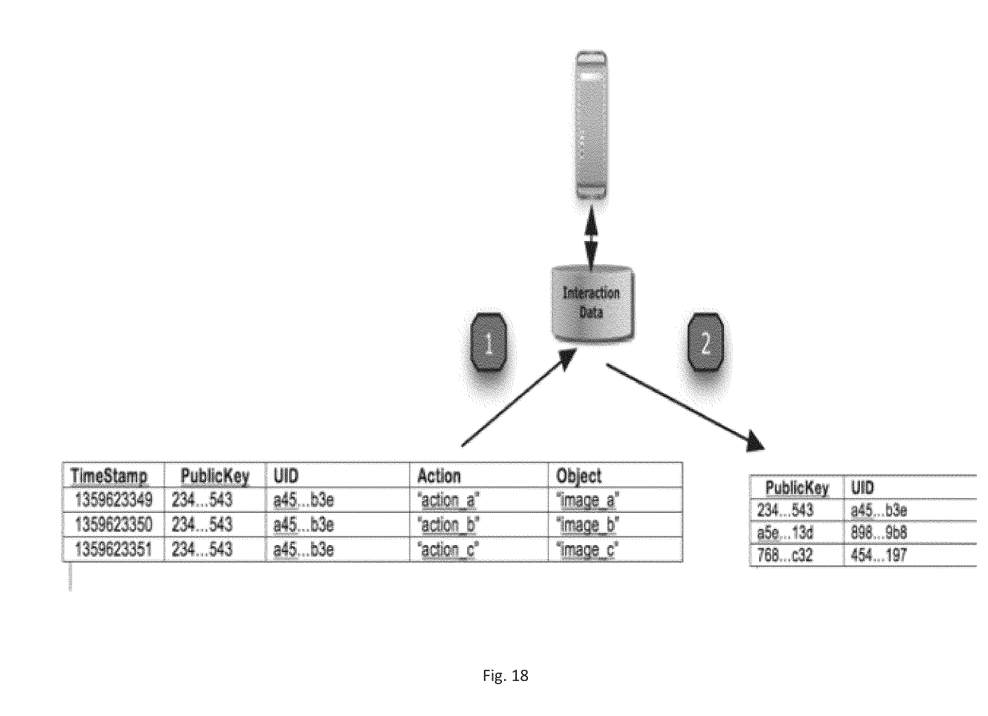

FIG. 18 shows the central server searching the database for all records with the desired actions and sequence (1), and constructing a temporary table (2) with the unique identifying information for those children. This information cannot be correlated with specific children without Verified Parental Consent.

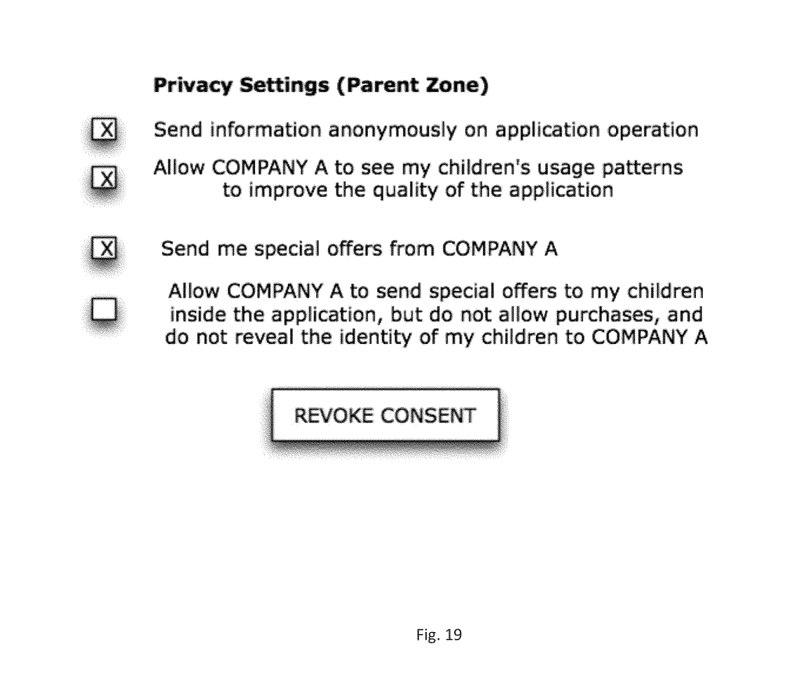

FIG. 19 shows one embodiment of providing parents with control over the use and visibility of their children's identity information. In the list of options, parents can completely disable usage data. They can also allow anonymous tracking of usage data. They can direct special offers to themselves (not the children) via email or other means. Or, they can enable children to receive targeted message without compromising their identity information. Finally, there is a button to completely revoke all consent granted by this parent to the software operator.

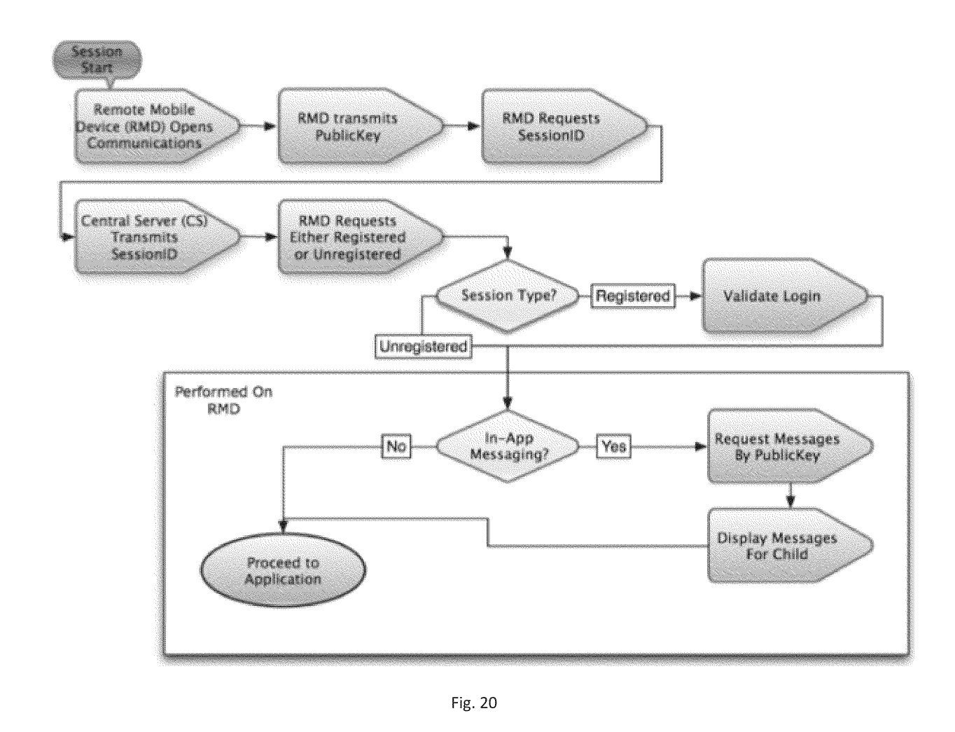

FIG. 20 shows a block flow diagram of the basic stages for permitting targeted messaging to children without revealing the children's identity to the message sender. The Remote Mobile Device (RMD) begins the session by contacting the Central Server (CS) (both shown in FIG. 11 above). Next, the RMD transmits the Public Key which was generated automatically when the application under examination was installed. In an alternative embodiment, this Public Key could be regenerated for every session to improve anonymity. Next, the RMD requests a SessionID, which the Server creates and sends for use in rapidly verifying that this RMD has a valid communications link open with the CS. Next, the RMD can request either a “registered” session (that is, a session where the identity of the parent, but not the children is known to the CS). Registered sessions are useful for associating more than one child with a particular parent for purposes of administering the system. If a “registered” session is requested, then a login challenge is presented and answered, which is well-understood technology in the industry.

Whether registered or unregistered, the next step is to determine whether a parent has authorized anonymous messaging of the child(ren) using the application on the RMD. The instant embodiment employs the selection screen shown in FIG. 19, but alternative embodiments are contemplated where usability and clarity can be improved. If the parent has denied consent for targeted messaging, then the application on the RMD proceeds to its main functions.

If, however, a parent has enabled targeted messaging, the RMD performs an additional step. The RMD requests any messages queued on the CS and intended for this Public Key, as indexed in FIG. 18 above. If one or more messages is queued on the CS for this Public Key, then the RMD displays the message for the child.

By way of illustration, assume that the subject application is one that displays games based on types of automobiles. Further, assume that the parent has granted consent for the child to receive targeted messaging from the software provider and the software provider's affiliates. Further, assume that the parent has granted consent for the software provider (alone) to know the identity of the children using the application, including their gender and age. Finally, assume that the software provider (and operator of the CS) desires to send an electronic coupon for a discounted purchase of a book about trucks to children who exhibit an interest in trucks, within a certain age bracket appropriate to the book.

In this example, the software provider would query its database for records displaying a pre-defined behavior pattern, which shows interest in trucks. By examining the actual behavior of all the children on the system, one or more specific children can be identified by Public Key (not by identity of the child). However, because the parent has consented, the Public Key can be matched with the Private Key in FIG. 16 above. This enables the CS to un-encrypt the UserID shown in FIG. 17 above. By referring to the un-encrypted UserID, the list of appropriate children can be narrowed by age (an attribute of the UserID record). This results in a list of PublicIDs which are associated with a specific message queued for delivery in the system.

Further in this example, on the RMD, the initialization sequence determines that there is one or more messages for this child, and displays them. In this example, the child who has shown an interest in several online truck games is given an electronic coupon for a discounted purchase of the book on trucks. Presumably, if the child is interested the book, the child and parent can use the electronic coupon to purchase the book at a discount.

It is important to note that the identity of which specific child receives the coupon is never revealed to the operator of the CS, nor the software provider, nor its affiliates. In this way, the disclosure safeguards children's identity online, without restricting them from receiving personalized attention.

In a second example, presume that security on the CS is breached, and outside persons (unauthorized) gain access to the data on the CS. By means of the instant disclosure, the identity of children and their behaviors is obscured from view, and impossible to be extracted for unauthorized use.

### Machine Embodiments

The methods and systems described herein may be deployed in part or in whole through a machine that executes computer software, program codes, and/or instructions on a processor. The processor may be part of a server, client, network infrastructure, mobile computing platform, stationary computing platform, or other computing platform. A processor may be any kind of computational or processing device capable of executing program instructions, codes, binary instructions and the like. The processor may be or include a signal processor, digital processor, embedded processor, microprocessor or any variant such as a co-processor (math co-processor, graphic co-processor, communication co-processor and the like) and the like that may directly or indirectly facilitate execution of program code or program instructions stored thereon. In addition, the processor may enable execution of multiple programs, threads, and codes. The threads may be executed simultaneously to enhance the performance of the processor and to facilitate simultaneous operations of the application. By way of implementation, methods, program codes, program instructions and the like described herein may be implemented in one or more thread. The thread may spawn other threads that may have assigned priorities associated with them; the processor may execute these threads based on priority or any other order based on instructions provided in the program code. The processor may include memory that stores methods, codes, instructions and programs as described herein and elsewhere. The processor may access a storage medium through an interface that may store methods, codes, and instructions as described herein and elsewhere. The storage medium associated with the processor for storing methods, programs, codes, program instructions or other type of instructions capable of being executed by the computing or processing device may include but may not be limited to one or more of a CD-ROM, DVD, memory, hard disk, flash drive, RAM, ROM, cache and the like.

A processor may include one or more cores that may enhance speed and performance of a multiprocessor. In embodiments, the process may be a dual core processor, quad core processors, other chip-level multiprocessor and the like that combine two or more independent cores (called a die).

The methods and systems described herein may be deployed in part or in whole through a machine that executes computer software on a server, client, firewall, gateway, hub, router, or other such computer and/or networking hardware. The software program may be associated with a server that may include a file server, print server, domain server, Internet server, intranet server and other variants such as secondary server, host server, distributed server and the like. The server may include one or more of memories, processors, computer readable media, storage media, ports (physical and virtual), communication devices, and interfaces capable of accessing other servers, clients, machines, and devices through a wired or a wireless medium, and the like. The server may execute the methods, programs or codes that are described herein and elsewhere. In addition, other devices required for execution of methods as described in this application may be considered as a part of the infrastructure associated with the server.

The server may provide an interface to other devices including, without limitation, clients, other servers, printers, database servers, print servers, file servers, communication servers, distributed servers and the like. Additionally, this coupling and/or connection may facilitate remote execution of program across the network. The networking of some or all of these devices may facilitate parallel processing of a program or method at one or more location without deviating from the scope. In addition, any of the devices attached to the server through an interface may include at least one storage medium capable of storing methods, programs, code and/or instructions. A central repository may provide program instructions to be executed on different devices. In this implementation, the remote repository may act as a storage medium for program code, instructions, and programs.

The software program may be associated with a client that may include a file client, print client, domain client, Internet client, intranet client and other variants such as secondary client, host client, distributed client and the like. The client may include one or more of memories, processors, computer readable media, storage media, ports (physical and virtual), communication devices, and interfaces capable of accessing other clients, servers, machines, and devices through a wired or a wireless medium, and the like. The client may execute the methods, programs or codes that are described herein and elsewhere. In addition, other devices required for execution of methods as described in this application may be considered as a part of the infrastructure associated with the client.

The client may provide an interface to other devices including, without limitation, servers, other clients, printers, database servers, print servers, file servers, communication servers, distributed servers and the like. Additionally, this coupling and/or connection may facilitate remote execution of program across the network. The networking of some or all of these devices may facilitate parallel processing of a program or method at one or more location without deviating from the scope. In addition, any of the devices attached to the client through an interface may include at least one storage medium capable of storing methods, programs, applications, code and/or instructions. A central repository may provide program instructions to be executed on different devices. In this implementation, the remote repository may act as a storage medium for program code, instructions, and programs.

The methods and systems described herein may be deployed in part or in whole through network infrastructures. The network infrastructure may include elements such as computing devices, servers, routers, hubs, firewalls, clients, personal computers, communication devices, routing devices and other active and passive devices, modules and/or components as known in the art. The computing and/or non-computing device(s) associated with the network infrastructure may include, apart from other components, a storage medium such as flash memory, buffer, stack, RAM, ROM and the like. The processes, methods, program codes, instructions described herein and elsewhere may be executed by one or more of the network infrastructural elements.

The methods, program codes, and instructions described herein and elsewhere may be implemented on a cellular network having multiple cells. The cellular network may either be frequency division multiple access (FDMA) network or code division multiple access (CDMA) network. The cellular network may include mobile devices, cell sites, base stations, repeaters, antennas, towers, and the like. The cell network may be a GSM, GPRS, 3G, EVDO, mesh, or other networks types.

The methods, programs codes, and instructions described herein and elsewhere may be implemented on or through mobile devices. The mobile devices may include navigation devices, cell phones, mobile phones, mobile personal digital assistants, laptops, palmtops, netbooks, pagers, electronic books readers, music players and the like. These devices may include, apart from other components, a storage medium such as a flash memory, buffer, RAM, ROM and one or more computing devices. The computing devices associated with mobile devices may be enabled to execute program codes, methods, and instructions stored thereon. Alternatively, the mobile devices may be configured to execute instructions in collaboration with other devices. The mobile devices may communicate with base stations interfaced with servers and configured to execute program codes. The mobile devices may communicate on a peer-to-peer network, mesh network, or other communications network. The program code may be stored on the storage medium associated with the server and executed by a computing device embedded within the server. The base station may include a computing device and a storage medium. The storage device may store program codes and instructions executed by the computing devices associated with the base station.

The computer software, program codes, and/or instructions may be stored and/or accessed on machine readable media that may include: computer components, devices, and recording media that retain digital data used for computing for some interval of time; semiconductor storage known as random access memory (RAM); mass storage typically for more permanent storage, such as optical discs, forms of magnetic storage like hard disks, tapes, drums, cards and other types; processor registers, cache memory, volatile memory, non-volatile memory; optical storage such as CD, DVD; removable media such as flash memory (e.g. USB sticks or keys), floppy disks, magnetic tape, paper tape, punch cards, standalone RAM disks, Zip drives, removable mass storage, off-line, and the like; other computer memory such as dynamic memory, static memory, read/write storage, mutable storage, read only, random access, sequential access, location addressable, file addressable, content addressable, network attached storage, storage area network, bar codes, magnetic ink, and the like.

The methods and systems described herein may transform physical and/or or intangible items from one state to another. The methods and systems described herein may also transform data representing physical and/or intangible items from one state to another.

The elements described and depicted herein, including in flow charts and block diagrams throughout the figures, imply logical boundaries between the elements. However, according to software or hardware engineering practices, the depicted elements and the functions thereof may be implemented on machines through computer executable media having a processor capable of executing program instructions stored thereon as a monolithic software structure, as standalone software modules, or as modules that employ external routines, code, services, and so forth, or any combination of these, and all such implementations may be within the scope of the present disclosure. Examples of such machines may include, but may not be limited to, personal digital assistants, laptops, personal computers, mobile phones, other handheld computing devices, medical equipment, wired or wireless communication devices, transducers, chips, calculators, satellites, tablet PCs, electronic books, gadgets, electronic devices, devices having artificial intelligence, computing devices, networking equipment, servers, routers and the like. Furthermore, the elements depicted in the flow chart and block diagrams or any other logical component may be implemented on a machine capable of executing program instructions. Thus, while the foregoing drawings and descriptions set forth functional aspects of the disclosed systems, no particular arrangement of software for implementing these functional aspects should be inferred from these descriptions unless explicitly stated or otherwise clear from the context. Similarly, it may be appreciated that the various steps identified and described above may be varied, and that the order of steps may be adapted to particular applications of the techniques disclosed herein. All such variations and modifications are intended to fall within the scope of this disclosure. As such, the depiction and/or description of an order for various steps should not be understood to require a particular order of execution for those steps, unless required by a particular application, or explicitly stated or otherwise clear from the context.

The methods and/or processes described above, and steps thereof, may be realized in hardware, software or any combination of hardware and software suitable for a particular application. The hardware may include a general-purpose computer and/or dedicated computing device or specific computing device or particular aspect or component of a specific computing device. The processes may be realized in one or more microprocessors, microcontrollers, embedded microcontrollers, programmable digital signal processors or other programmable device, along with internal and/or external memory. The processes may also, or instead, be embodied in an application specific integrated circuit, a programmable gate array, programmable array logic, or any other device or combination of devices that may be configured to process electronic signals. It may further be appreciated that one or more of the processes may be realized as a computer executable code capable of being executed on a machine-readable medium.

The computer executable code may be created using a structured programming language such as C, an object oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and software, or any other machine capable of executing program instructions.

Thus, in one aspect, each method described above and combinations thereof may be embodied in computer executable code that, when executing on one or more computing devices, performs the steps thereof. In another aspect, the methods may be embodied in systems that perform the steps thereof, and may be distributed across devices in a number of ways, or all of the functionality may be integrated into a dedicated, standalone device or other hardware. In another aspect, the means for performing the steps associated with the processes described above may include any of the hardware and/or software described above. All such permutations and combinations are intended to fall within the scope of the present disclosure.

While the methods and systems described herein have been disclosed in connection with certain preferred embodiments shown and described in detail, various modifications and improvements thereon may become readily apparent to those skilled in the art. Accordingly, the spirit and scope of the methods and systems described herein is not to be limited by the foregoing examples, but is to be understood in the broadest sense allowable by law.

All documents referenced herein are hereby incorporated by reference.

What is claimed is:

1. A method of determining a measure of media items that are accessible via metadata stored in a Playpack, comprising:
determining a platform assessment score that includes a screen score, a network factor, a network speed, and a touch screen score;
determining a viewer assessment score that includes a presentation score, a duration score, a taxonomy score, and repeated view tolerance score;
determining a content assessment score that includes a popularity weighting score and a quality score; and
ordering the media items based on content assessment score and viewer assessment score

2. The method of claim 1, wherein the quality score is based on comparing platform assessment score factors with media item meta data.

3. A method of determining a presentation order of media items that are accessible via metadata stored in a Playpack, comprising:
determining a platform assessment score that includes a screen score, a network factor, a network speed, and a touch screen score;
determining a viewer assessment score that includes a presentation score, a duration score, a taxonomy score, and repeated view tolerance score;
determining a content popularity weighting score;
determining a content quality score that is based on comparing platform assessment score factors with media item meta data;
ordering the media items based on content popularity weighting score, content quality score and viewer assessment score; and
applying a scatter algorithm to re-order the ordered media items based on a viewer repetition tolerance factor.

4. A method operable on a digital Computer Server (CS) and one or more Remote Computing Devices (RMD), comprising:
encrypting an identity of a child operating an application on the RMD with a two-way encryption algorithm use a public encryption key and a secret encryption key;
storing the encrypted identity in a memory that is accessible by the CS;
storing the secret encryption key separately from the encrypted identity;
transmitting child RMD operator usage data from the RMD to the CS; and
storing the RMD operator usage data with reference to only the public encryption key.
